(19) United States
(12) Patent Application Publication
(10) Pub. No.: US 2026/0200614 A1
(43) Pub. Date: Jul. 16, 2026

(54) AIR-TIGHT LONGITUDINAL SEALING SEAM FOR THIN FILMS

(71) Applicant: HOCHLAND SE, HEIMENKIRCH (DE)

(72) Inventors: JOHANNES BADER, ARGENBUEHL (DE); JUERGEN SINGER, WESTERHEIM (DE); JOSEF FERBER, LINDENBERG (DE)

(73) Assignee: HOCHLAND SE, HEIMENKIRCH (DE)

(21) Appl. No.: 19/136,297

(22) PCT Filed: Dec. 7, 2023
(86) PCT No.: PCT/EP2023/084708

§ 371 Date: Jun. 6, 2025

(30) Foreign Application Priority Data
Dec. 8, 2022 (DE) 10 2022 132 700.0

(51) Int. Cl. B65B 9/04; B65B 51/16; B65B 51/20; B65B 51/26

(52) U.S. Cl. CPC B65B 9/04; B65B 51/16; B65B 51/20; B65B 51/26

(57) ABSTRACT

A method for producing a sealing seam which joins two film sides. The method includes performing a pre-sealing process and a final sealing process. The pre-sealing process includes heating at least one film side of the two film sides, and, in a heated state of the at least one film side, bringing the two film sides into contact with one another to form a pre-sealing seam which joins the two film sides together. The final sealing process includes supplying the pre-sealing seam at a transport speed to a pressing device which is arranged downstream of the pre-sealing process, and applying a force via the pressing device to at least one film side of the two film sides along the pre-sealing seam substantially perpendicular to the transport direction to transform the pre-sealing seam into a final sealing seam which is substantially impermeable to air.

### CROSS REFERENCE TO PRIOR APPLICATIONS

This application is a U.S. National Phase application under 35 U.S.C. § 371 of International Application No. PCT/EP2023/084708, filed on Dec. 7, 2023 and which claims benefit to German Patent Application No. 10 2022 132 700.0, filed on Dec. 8, 2022. The International Application was published in German on Jun. 13, 2024 as WO 2024/121305 A1 under PCT Article 21(2).

### FIELD

The present invention relates to an air-tight longitudinal sealing seam for thin films, such as those used in particular in the food industry for enclosing foodstuffs, in particular cheese. It is here important that air-tight seams can be created to prevent foodstuffs from reacting with, for example, oxygen, and thus losing their desired properties. In addition to foodstuffs, this can of course also apply to other products that can be placed in such a thin film. The present invention also relates to techniques for producing such an air-tight longitudinal sealing seam.

### BACKGROUND

The following solutions for creating a sealing seam, in particular a longitudinal seam, are known from the prior art:

U.S. Pat. No. 5,112,632 describes a device and method for producing an air-tight sealed package for a slice of food. An air-tight longitudinal seam is here created between two film sides by passing both film sides through a heated wave-shaped tubular arrangement, wherein the waves of the tubular arrangement alternately apply pressure to each side of the film. Disadvantageous here is that the film is subjected to high mechanical stress during this process, in particular friction, which can damage the film and in particular prevents the films from falling below a certain thickness. U.S. Pat. No. 5,112,632 uses a so-called V-tube therefor.

DE 198 04 221 A1 describes the production of a longitudinal seam using a low-friction, in particular a contactless method, in which two sides of the film, in particular an O-shaped film tube, are blown on one side using hot air nozzles, thereby forming a sealing seam between the two sides of the film along an elongated blowing line. The disadvantage here is that the longitudinal seam created thereby is not air-tight.

### SUMMARY

An aspect of the present invention is to provide techniques which make it possible to produce an at least largely air-tight sealing seam on films with as little friction as possible. A further aspect of the present invention is to at least partially eliminate the disadvantages of the prior art mentioned above via the techniques here presented.

In an embodiment, the present invention provides a method for producing a sealing seam which joins two film sides. The method includes performing a pre-sealing process and performing a final sealing process. The pre-sealing process comprises heating at least one film side of the two film sides, and, in a heated state of the at least one film side, bringing both of the two film sides into contact with one another so as to form a pre-sealing seam which joins the two film sides together as a film. The final sealing process comprises supplying the pre-sealing seam at a transport speed to a pressing device which is arranged downstream of the pre-sealing process, and applying a force via the pressing device to at least one film side of the two film sides along the pre-sealing seam substantially perpendicular to the transport direction so as to transform the pre-sealing seam into a final sealing seam which is substantially impermeable to air.

### BRIEF DESCRIPTION OF THE DRAWINGS

The present invention is described in greater detail below on the basis of embodiments and of the drawings in which:

FIG. 1 shows a lateral section of a pre-sealing apparatus for producing a film tube with a pre-sealing seam;

FIG. 2 shows a front view of the sealing apparatus with a view of the outlet nozzles;

FIG. 3 Illustrates a cross section of a final sealing device;

FIG. 4 illustrates a further exemplary embodiment of the final sealing device;

FIG. 5 schematically shows an overall process for producing a tight film packaging;

FIG. 6 shows in detail a transverse sealing apparatus of the overall process according to FIG. 5;

FIG. 7 shows a tight inner film packaging which has at least one air-tight sealing seam according to the present invention;

FIG. 8 shows a section through a combination packaging;

FIG. 9 shows a top view of the air-tight sealing seam according to the present invention;

FIG. 10 shows a top view of another sealing seam produced using a different method from the prior art; and

FIG. 11 shows a top view of a further sealing seam produced using a further method from the prior art.

### DETAILED DESCRIPTION

The features of the various aspects of the present invention or of the various exemplary embodiments described below can be combined with one another, unless this is explicitly excluded or is necessarily technically impossible.

The present invention provides a method for producing a sealing seam which air-tightly joins two film sides, in particular two film sides of a film in the formation of a film tube. This method can in particular be used in the packaging of foodstuffs, for example, in the packaging of cheese. The method comprises the following steps:

A step of carrying out a pre-sealing process, wherein at least one of the two film sides is heated in a pre-sealing process and wherein, in the heated state of the at least one film side, both film sides are brought into contact with one another, wherein a pre-sealing seam is formed which joins the two film sides together.

The pre-sealing seam here still has a certain air permeability. The air permeability is undesirable, in particular because the air permeability is so high that foodstuffs cannot be sealed air-tight when the film is further processed into packaging for foodstuffs in a later process. A sealing layer of the film is activated by heating the film so that the two sides of the film stick together and adhere to one another, at least to a certain extent, without the rest of the film being “melted”. The temperature at which the sealing layer is activated is, for example, therefore lower than the temperature that would cause structural damage to the remaining layers of the film.

The pre-sealing process can in principle be realized by various techniques as long as this process comprises supplying the film in a heated state to the final sealing process described below. This in principle also comprises the possibility of reheating a film with a pre-sealing seam that has already cooled down. A pre-sealing process using a hot air bar can, for example, be used, which is described in detail below.

A step of carrying out a final sealing process, wherein the pre-sealing seam is supplied at a transport speed to a pressing device, wherein, in terms of the process, the pressing device is arranged downstream of the pre-sealing process, in particular as close as structurally possible, and wherein the pressing device applies force to at least one of the two film sides along the pre-sealing seam substantially perpendicularly to the transport direction, as a result of which the pre-sealing seam is made into a final sealing seam which is substantially impermeable to air.

The transport speed at which the pre-sealing seam on the film is supplied to the pressing device in particular corresponds to the transport speed of the film in upstream and/or downstream processing steps of the film so that the film is neither built up too much nor stretched too much. It may be necessary, however, to transport the film at a slightly higher transport speed in downstream processes because an increased tension of the film can lead to a higher sealing pressure of the pressing device.

The closer (in terms of the process) the pressing device is arranged downstream of the pre-sealing process, the less the pre-sealing seam cools down and the more effectively the pressing device can create an air-tight final sealing seam; however, it is still the case that the temperature of the pre-sealing seam when it reaches the final sealing apparatus is still at least slightly lower than in the pre-sealing apparatus.

The force of the pressing device can, for example, acts perpendicular to the local flat surface formed by the film in the area of the pre-sealing seam. If the pre-sealing seam is created in an exemplary embodiment in which the film is formed as a film tube, it is of course not possible to say that the “entire film” has a film plane. This is why the term “local flat surface in the area of the pre-sealing seam” is used in this context.

In the case of a film tube, this forms a continuous longitudinal seam into which a product, in particular cheese, can be inserted and which is then transformed into individual portions by a final transverse sealing.

The repeated processing of the pre-sealing seam according to the present invention has the technical effect of creating an air-tight final sealing seam from a non-air-tight pre-sealing seam. It is a particular advantage of the present invention that the resulting tight final sealing seam makes it possible to produce tight inner packaging for packaging foodstuffs, in particular cheese, so that alternative outer packaging materials such as paper can be used or outer packaging can be dispensed with altogether. It is additionally not necessary to place the tight inner packaging in a fumigated (CO₂ atmosphere) “tight” outer packaging, thus preventing the foodstuffs from reacting with the ambient air.

Tight packaging, which in particular has at least one longitudinal seam and conventionally two transverse sealing seams, is also referred to as tight discs. Such tight packaging is also referred to as first packaging or inner packaging if it is packaged again in outer packaging, also referred to as second packaging or outer packaging. In cheese production, for example, several cheese slices, each of which is individually wrapped in an inner packaging (so-called IWS) are again packed together in a larger outer packaging.

In an embodiment, the pressing device can, for example, project into a transport plane of the transport direction of the pre-sealing seam, as a result of which the pre-sealing seam runs around the pressing device and the force is thereby applied to at least one side of the pre-sealing seam. The transport plane is here the local transport plane that forms in the area of the pre-sealing seam.

This has the technical effect that a pressure, also known as sealing pressure, acts on the pre-sealing seam simply due to the, for example, structurally simple arrangement of the pressing device. This way of passively applying pressure is very low-maintenance and is generally only subject to very small fluctuations, which can be essential for the success of the process, in particular with thin films. This sealing pressure generally results from the interaction of the external design of the pressing device, how far the pressing device projects into the transport plane of the film, and the film tension. However, in order to change the sealing pressure, it is best to make changes to the pressing device, e.g., how far the pressing device projects into the transport plane. A simple adjusting screw or a technically automated unit can be used to adjust how far the pressing device projects into the transport plane.

The pressing device can, for example, be designed as a roller.

This provides, in a technically advantageous manner, that a very uniform force is applied in the radial direction from the center of the roller to the pre-sealing seam. With thin films it is in particular important to avoid peaks when applying force so that the film is not damaged. The round outer shape of the roller provides this particularly advantageously if the pre-sealing seam runs at least in sections along the outer circumference of the roller.

In an embodiment, the roller can, for example, be designed as a passive roller that can be driven by friction with the film, in particular by friction with the pre-sealing seam.

The advantage of a passive roller is that it need not have be driven by another motor in synchronization with the transport speed, but is automatically brought to the correct speed by friction with the film. This is particularly advantageous when the transport speed of the film shows fluctuations to which an external motor can only react with difficulty or only with a certain delay. It is particularly advantageous to provide the passive roller on a very low-friction ball bearing or roller bearing. A tangential frictional force on the film and in particular on the pre-sealing seam can thereby be advantageously significantly reduced.

In an embodiment, the roller can, for example, have a smooth outer surface and/or, at least on the outer surface, a material with a high heat storage capacity, such as stainless steel.

The smooth surface also has the advantage of minimizing pressure peaks that can cause damage to the film. If the outer surface is at least partially made of a material with a high heat storage coefficient, the roller can also assume an increased temperature during the method, which improves the final sealing process. The roller can receive heat from the heated pre-sealing seam and/or from being positioned close to the pre-sealing apparatus. If, for example, the pre-sealing seam is made with hot air nozzles, this heat radiates onto the roller due to its position close to the hot air nozzles and heats it in addition to the sealing seam. In an embodiment, the roller can also be connected to another heat source that transfers energy to the roller.

A counterpressure can, for example, be achieved on the opposite side of the pressing device by applying force to a fluid. This counterpressure has the technical effect that the sealing pressure of the pressing device can act effectively on the pre-sealing seam and does not “disappear”. This also provides the technical effect that the counterpressure can be generated very gently and with as little friction as possible in order to protect the film, which is particularly necessary with thin films. The fluid can, for example, be air in that air provides a kind of virtually frictionless counterpressure cushion in a very special way. Other fluids, such as water or oils, are less compliant than air, but can still in principle be used. If foodstuffs are to be packaged in the films, the use of food-safe fluids is in particular provided.

The fluids can, for example, be supplied to a point opposite the pressing device at a defined pressure and/or a defined temperature. In the embodiment with air as the fluid, the air can be blown at the defined pressure and/or the defined temperature, in particular using nozzles, onto the side of the pre-sealing seam opposite the roller. The other fluids mentioned above can also be supplied to the roller using nozzles on the opposite side of the pre-sealing seam. Another advantage of using air as a fluid is that the air need not be collected and/or disposed of. A higher and more consistent pressure can be generated when using oil as a fluid.

It may in particular be provided to supply the fluid in a heated state to the side of the pre-sealing seam opposite the roller. This also has an advantageous effect on the final sealing seam.

Any temperature-related features that have an advantageous effect on the final sealing seam can have the consequence of varying the parameters (for example, using a lower indentation depth T1) so that the mechanical stress on the film can be further reduced, thereby making it possible to even use thinner films.

It is alternatively possible to generate the counterpressure on the opposite side of the pressing device using a further roller. In this case, the film with the pre-sealing seam is supplied through an arrangement of two rollers, wherein at least one of the rollers can be heated. The gap between the two rollers through which the film is supplied is then, in particular, smaller than the film thickness so that the sealing pressure can be generated. In an advantageous manner compared to the variant without the second roller, this alternative can in principle generate significantly more pressure on the pre-sealing seam, which can be advantageous for some films that require a higher sealing pressure. This is particularly likely to be the case the thicker the film is, for example over 25 μm.

In an embodiment, the pre-sealing seam of the pre-sealing process can, for example, be created by blowing hot air onto the film.

This activates at least one sealing layer of the film and the two film sides can stick together in such a way that the pre-sealing seam is formed. Blowing hot air onto at least one of the film sides is particularly low-friction and gentle on the film. This method is particularly suitable for thin films. The blowing can be realized, for example, by at least one hot air bar comprising a plurality of outlet nozzles from which heated air flows out. Only one side of the superimposed upon one another film sides can, for example, be blown by the hot air bar. The blowing also provides that one side of the film exerts a certain amount of pressure on the other side, thereby allowing the pre-sealing seam to form.

The pre-sealing process can, for example, be in particular be characterized in that the heating of at least one film side and the bringing of the two film sides into contact is realized by blowing heated air onto the at least one film side. Conveniently, at least one film side has a sealing layer which is activated by heating without the remaining film melting at the activation temperature. The activated sealing layer has adhesive properties for joining the two film sides.

The pre-sealing process, which can also be referred to as the first sealing process, can therefore, for example, be characterized by the fact that the welding of overlapping films is carried out without contact by hot air, as a result of which a first sealing seam is created, in particular a first longitudinal sealing seam is created. The first sealing seam is also referred to as the pre-sealing seam in that it does not yet have the desired final properties in terms of air-tightness.

It may in particular be provided that the hot air for sealing the film of the pre-sealing process is generated from ordinary compressed air, which is heated to a temperature of approximately 170 to 300° C. by a suitable heating apparatuses and supplied to the film tube via nozzles. The temperature and/or quantity of hot air supplied can be regulated and quickly adjusted to the required conditions.

A pre-sealing apparatus of the pre-sealing process can, for example, comprise a housing with at least one air inlet for the compressed air, wherein the compressed air can branch out within the housing in a series of distribution channels, wherein the air can then be supplied from the distribution channels via overflow channels to at least one heating apparatus. The air heated there is then supplied to an outlet channel via overflow channels and applied to the film tube via nozzles.

The pre-sealing apparatus, i.e., in particular the outlet nozzles for the hot air, are arranged at a defined distance from the film tube and do not touch it.

A substantial advantage of the pre-sealing process with hot air is that thinner films can be used to produce the film tube in that no “destructive” contact exists between the film and the sealing apparatus. This results in significant cost savings on film material. In principle, the thinner the film, the faster the heating can take place.

A further advantage is that various parameters of the sealing apparatus, such as temperature, pressure of the incoming cold compressed air, and flow volume of the compressed air, can be set over a wide range without having to make any other structural changes to the rest of the system. The non-contact pre-welding allows the speed of the film tube to be increased.

If only the pre-sealing process is used, however, it is not possible to create a tight sealing seam. A further highlight of the present invention is therefore the special combination, also in terms of the process sequence, of the pre-sealing process and the final sealing process. Both processes in themselves are not capable of creating a tight sealing seam. An idea of the present invention is, for example, therefore to combine these two processes so that the tight sealing seam is created. This idea is also inventive in that it would be apparent for reasons of efficiency to optimize a single process instead of combining the pre-sealing process and the final sealing process.

The two film sides form an O-film tube, wherein one side of the film, which is also referred to as the inner side, can, for example, rest on the other side of the film, which is also referred to as the outer side.

The sealing layer can accordingly be provided variably on the inner and/or outer side of the film. Contact between the sealing layer and the foodstuff inside the film tube is minimized if the sealing layer is provided on the outer side of the film. This can be advantageous if the sealing layer contains components that are in particular not food-safe. The use of an O-film tube is also advantageous because it is always under a certain amount of tension. Less material is also required for the O-film tube than for the V-tube type. With the V-tube type, the opening flaps of the inner packaging are generated from both sides of the film (inside to inside).

The film can, for example, have a thickness of less than 30 μm.

This has the advantage that less film material must be used which saves on costs while at the same time protecting the environment. It is surprising that a film with a thickness of less than 30 μm can be used to create a packaging which has at least the above-described final sealing seam with the air-tight properties. This is made possible via the final sealing process described above and, in particular, by combining the final sealing process with the pre-sealing process of the pre-sealing apparatus. These processes are both very gentle on the material so that such thin films can be used. In particular, the thinner the film, the better the one-sided blowing of hot air onto the film.

The final sealing seam is also referred to as the longitudinal sealing seam, as it is substantially parallel to the transport direction of the film. If a single film has previously been folded over one another in terms of the process, either to form a V-tube or, for example, an O-tube, the film is already sealed at this folding point. The longitudinal sealing seam is typically parallel to the fold. In the transport direction, the tubular bag is then only open at the top and bottom. A product, in particular foodstuffs, for example, cheese, can be filled in through these openings. To provide that the tubular bag encloses the product, the foodstuff or the cheese, in particular in an air-tight manner, a transverse seal is made transverse to the direction of transport in a subsequent process step. It is known from the prior art how an air-tight transverse seal is to be made and how the product tube can be separated along the cross-sectional settlements after the transverse sealing so that an air-tight film packaging is created overall. This packaging is also referred to as inner packaging or first packaging below. As this packaging is made of film, it can also be referred to as inner film packaging or first film packaging.

A second aspect of the present invention provides a device for producing an air-tight sealing seam which joins two film sides, in particular two film sides of a film in the form of a film tube. The device is in particular configured for carrying out the method described above. The air-tight longitudinal sealing seam is in particular a longitudinal sealing seam. The device for producing the air-tight sealing seam comprises:

A pre-sealing apparatus which is configured for carrying out a pre-sealing process, wherein at least one of the two film sides is heated in a pre-sealing process by a heating device of the pre-sealing apparatus, and wherein, in the heated state of the at least one film side, both film sides are brought into contact with one another, wherein a pre-sealing seam is formed which joins the two film sides together.

The pre-sealing apparatus is in particular designed so that the film can be guided through the pre-sealing apparatus. The pre-sealing apparatus can also have a guide therefor.

The heating device can in particular also be designed to bring the two film sides into contact with one another. In one embodiment, the heating device, as described above, is designed as a hot air bar with several nozzles through which hot air flows so that at least one side of the film is heated directly and is subjected to a force by the air pressure and pressed onto the other film side.

A final device is arranged downstream of the pre-sealing apparatus in terms of the process and is configured for carry out a final sealing process. The final device has a pressing device which is arranged so that the pre-sealing seam can be supplied to the pressing device at a transport speed and so that at least one of the two heated film sides can be subjected to force which is substantially perpendicular to the transport direction along the pre-sealing seam via the pressing device.

The advantages of the device for producing an air-tight sealing seam are substantially analogous to those described in connection with the method explained above.

A third aspect of the present invention provides a device for producing an air-tight film packaging which comprises the device described above for producing an air-tight sealing seam, in particular an air-tight longitudinal sealing seam, and, in terms of the process, a transverse sealing apparatus downstream thereof, wherein a film tube comprising at least one air-tight longitudinal sealing seam exits the device for producing an air-tight film packaging and is supplied to the transverse sealing apparatus. The transverse sealing apparatus is configured to provide two transverse seals transverse to the transport direction of the film tube and to separate the film tube into individual air-tight packaging. In terms of the process, an influencing device can in particular be provided between the final sealing device, the influencing device creating an air-tight longitudinal seam, and the transverse sealing apparatus in order to introduce products, in particular foodstuffs, into the still open film tube. The film can, for example, have a thickness of less than 30 μm.

The device according to the present invention for producing an air-tight film packaging thus for the first time makes it possible to provide air-tight film packaging, so-called IWS, with extremely thin films, so that resources and the environment are efficiently conserved and the products, in particular foodstuffs, are nevertheless sealed air-tight inside the film packaging.

A fourth aspect of the present invention provides an air-tight sealing seam which is obtainable via the method described above. The air-tight sealing seam corresponds to the final sealing seam, so that both terms are equivalent.

This sealing seam can advantageously be used to produce an air-tight film packaging, in particular for foodstuffs such as cheese.

A further aspect of the present invention provides an air-tight film packaging, in particular for foodstuffs, which has at least the air-tight sealing seam described above and which is produced by the method according to the present invention, in particular as an air-tight longitudinal sealing seam. The packaging can, for example, have two further transverse seals.

This is the first air-tight film packaging with a longitudinal sealing seam created by the method, in particular for films thinner than 30 μm. The film packaging according to the present invention is therefore particularly suitable for foodstuffs that should not contact ambient air while at the same time being extremely environmentally friendly and resource-saving in that extremely thin films can for the first time be used.

A further aspect of the present invention provides a combination packaging consisting of an air-permeable outer packaging (also referred to as outer packaging) and the air-tight film packaging described above (also referred to as inner packaging) for the storage of air-sensitive foodstuffs.

This is the first combination packaging whose outer packaging can consist of an air-permeable material, such as paper, and an inner packaging, in particular with a film thinner than 30 μm. The outer packaging previously had to be air-tight and additionally fumigated to prevent the foodstuffs inside the inner packaging from reacting with air, in particular ambient air.

The innovative combination packaging not only makes it possible to save film in the inner packaging, but also to dispense with film completely in the outer packaging. The outer packaging therefore only needs to be suitable for holding several individual slices together. Several, e.g., 10, individual slices of processed cheese are typically contained in a single outer packaging and can be better offered and sold in this way.

The air-tight film packaging described above is also referred to as tight individual film packaging, in particular individual film packaging for foodstuffs. This type of individual film packaging is also known in the trade as an IWS slice (IWS=individual wrapped slice).

In other words, the tight individual film packaging offers the advantage that in particular, foodstuffs contained inside the tight individual film packaging do not react with the ambient air and thus do not undergo any adverse changes in their properties.

This advantageously allows the tight individual film packaging to be used as an inner packaging surrounded by an outer packaging that no longer needs to be air-tight, and allows that the intermediate space between the outer and inner packaging no longer needs to be fumigated, in particular with carbon dioxide, to prevent the foodstuffs from reacting with the oxygen in the air, as was conventionally indicated. To prevent the carbon dioxide from escaping from the intermediate space between the inner and outer packaging, the outer packaging was conventionally formed by a tight outer packaging made of a plastic film with a barrier. Due to the present invention, the outer packaging can now be made from paper, in particular at least to a large extent, which provides significant advantages from an environmental point of view, as film can be reduced efficiently. This type of outer packaging is much more sustainable and is also increasingly in demand and required by politicians and customers.

The outer packaging can also be made of plastic, but this no longer needs to be fumigated. This outer packaging (whether film or paper) can, for example, be opaque in order to prevent the foodstuffs from reacting with light.

A further aspect of the present invention provides that the combination packaging already described above can also be additionally or alternatively designed as follows: combination packaging comprising an inner air-tight film packaging, in particular comprising at least the inventive air-tight sealing seam described above, and an outer packaging as described above surrounding the inner air-tight film packaging, wherein the intermediate space between the outer packaging and the inner packaging is unfumigated. The term “unfumigated” here means that no extra gas such as carbon dioxide is introduced into the intermediate space, as is conventionally the case, so that a reaction of a foodstuff, i.e., in particular cheese, with ambient air is prevented. If there is, for example, normal ambient air in the intermediate space, then this state is considered “unfumigated” in the context of the present invention. In The outer packaging is in particular at least substantially opaque, i.e., impermeable to light.

This in particular makes it possible to offer cheese slices from a mix of an air-tight film-based inner packaging and an outer paper-based outer packaging, i.e., the outer packaging, to a customer in a store.

The following numerical example illustrates this: The proportion of paper in the overall packaging can be between 20-80%, for example, between 25-75%, for example, between 30-65%. Compared to conventional packaging, this results in less packaging material, which saves CO₂ in the production of the packaging. The outer packaging can, for example, be formed by a tubular bag made of paper which has a weight of 2.00 g/end-user unit and the film-based inner packaging can, for example, be a film made of PP/EVA material with a film thickness of 23 μm or less.

Further advantageous design features of the present invention are set forth in the claims.

Exemplary embodiments of the present invention are explained below with reference to the accompanying drawings. Numerous features of the present invention are thereby explained in detail below with reference to the exemplary embodiments. The present disclosure is not, however, limited to the specifically mentioned combinations of features. The features mentioned here can much rather be combined as desired to form embodiments according to the present invention unless expressly excluded below.

A special feature of the method is, in particular, the combination of the pre-sealing via hot air and the final sealing via a passive roller so that the frictional forces and/or the mechanical stress generated on the film is extremely low, thereby allowing the films to be made very thin, which leads to a considerable reduction in the film material and thus to a strong protection of the environment. In particular for pre-sealing using hot air, the thinner the film, the more efficiently the sealing layer of at least one film side is heated.

Examples of specifications for the film that are particularly well suited to the method of the present invention are therefore listed below.

The film should have a thickness of between 10 and 30 μm, for example, less than 25 μm, in particular less than or equal to 23 μm, or, for example, less than or equal to 21 μm, for example, between 15 and 20 μm. The technical limit for films is currently 12 μm or 10 μm for OPET film (OPET=biaxially oriented polyester: rigid OPET with sealing lacquer on both sides) or for the thinnest possible OPP film (OPP=biaxially oriented polypropylene: OPP with sealing material) with a sealing layer on both sides—polymers or sealing lacquer.

The film can, for example, be made up of 2 to 30 layers. At least one outer layer is a sealing layer comprising polymers or sealing lacquer. If sealing layers are provided on both sides of the film, the film comprises 3-30 layers. The middle layer or middle layers are made of a PP, OPP or OPET. PP layers consist of a mixture or layers of different PP types. PP films are extruded polypropylene films. “Cast PP” (with a sealing layer on both sides) is in particular often used in the food industry due to its preferred properties.

The final sealing seam differs from the pre-sealing seam in that the former is wider. Depending on the film type, differences can also be observed in terms of tear behavior; at the final sealing seam, the sealing layer is substantially completely peeled off the carrier layer, which is visually apparent. This means that an adhesion break can occur between the sealing layer and the carrier layer.

The air-tightness of the inner packaging, in particular the sealing seams, is measured using a method with hydrogen as a tracer gas under overpressure in the packaging. The maximum concentration of escaping hydrogen along at least one sealing seam on the outside must not exceed a maximum concentration of 10 ppm, for example, a concentration of less than 7 ppm, for example, less than 5 ppm, for example, less than 3 ppm. This measurement method is used to define and verify air-tightness. This limit value must be achieved by at least 80%, for example, 85%, for example, 90%, for example, 99% of the measured products.

Sealing generally depends on three factors: time, pressure and temperature. The films used for the method according to the present invention can in principle already be sealed at temperatures of around 100° C. The films can, for example, be heated to a temperature between 170° C. and 300° C. for the pre-sealing process. If a final sealing process is also planned, it may in principle be advisable to heat the film to over 200° C. It is also possible, however, to use lower temperatures by varying the three factors of time, pressure and temperature accordingly.

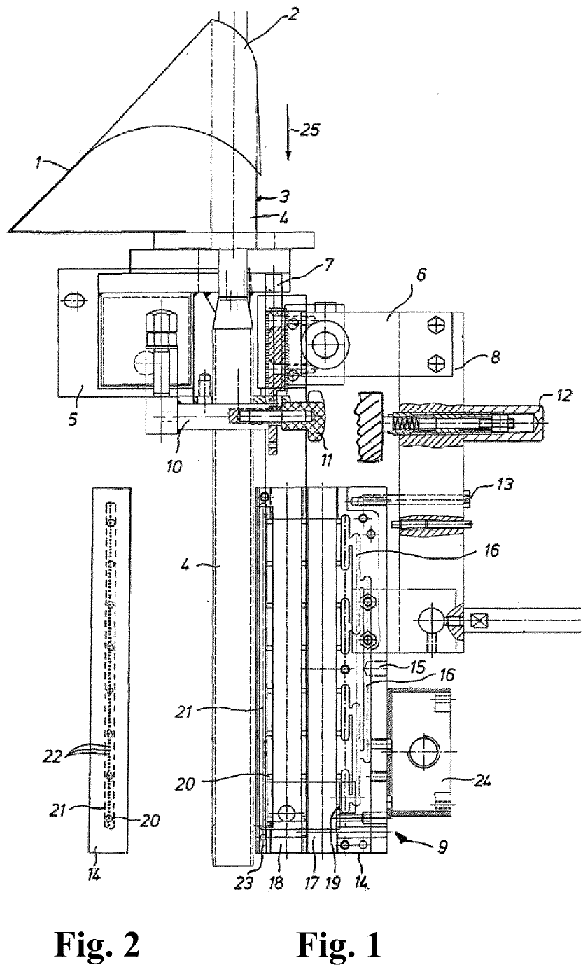

FIG. 1 shows a lateral section of a pre-sealing apparatus 9 for producing a film tube with a pre-sealing seam 32:

A film 1, in particular a flat film web 1, which can, for example, be made of plastic, is unwound from a reel (not shown) and passes continuously to a forming apparatus consisting of a forming shoulder 2, through which the flat film web 1 is formed into a film tube 3 with overlapping film edges, which is open on the longitudinal side, and is transported further on a cylindrical forming tube 4 in the transport direction 25 at a transport speed. The forming shoulder 2 and the forming tube 4 are held in a holder 5.

The forming tube 4 extends further in the transport direction 25 into an area of the pre-sealing apparatus 9, which is attached to a suspension 6 on a machine housing. The suspension 6 is mounted rotatably about a vertical axis in a pivot bearing 7, wherein the suspension 6 can be locked by a fastening screw 11, which is part of a pivot arm 10 attached to the holder 5. This firmly connects the suspension 6 to the holder 5 in order to prevent unintentional pivoting.

The housing 14 of the actual pre-sealing apparatus 9 is connected to the suspension 6 via a fastening arm 8. Various adjustment devices are provided in order to be able to carry out an orientation of the housing 14 in relation to the forming tube 4. There is a stop adjustment 12, which is supported on the machine housing and via which the distance between the housing 14 of the pre-sealing apparatus 9 and the forming tube 4 can be adjusted. Furthermore is provided an inclination adjustment 13 via which the inclination of the housing 14 relative to the axis of the forming tube 4 can be adjusted. This allows a uniform distance to be set between the housing 14 of the pre-sealing apparatus 9 and the forming tube 4 over the length of the forming tube 4.

The housing 14 of the pre-sealing apparatus 9 has at least one air inlet 15, wherein the incoming compressed air is distributed within the housing 14 via tree-like branching distribution channels 16 and is spatially distributed via overflow channels 19 to a heating apparatus. The heating apparatus comprises, for example, a first heating cartridge 17 to which a second heating cartridge 18 is connected. The heating cartridges 17, 18 are roughly tubular in shape and have at least one electrically heatable heating coil which heats the compressed air flowing into the inner volume of the heating cartridge. The heated hot air exits the heating cartridge 18 via overflow channels 20 and reaches an outlet channel 21, which is arranged parallel to the forming tube 4 in the longitudinal direction.

FIG. 2 shows that the outlet channel 21 has a plurality of outlet nozzles 22 on the side facing the forming tube 4 through which the hot air emerges and impinges on the film tube 3 guided along the forming tube 4. The film tube 3 is oriented on the forming tube 4 so that the overlapping film edges come to lie opposite the outlet nozzles 22 and are continuously welded together by the emerging hot air in a pre-sealing process to form a pre-sealing seam 32. However, the pre-sealing seam 32 created in this way still exhibits increased air permeability. It is substantially important that the pre-sealing apparatus 9 “does not touch” the surface of the film tube 3, but that the sealing takes place without contact.

A temperature sensor 23 is arranged in the area of the outlet channel 21 via which the temperature of the hot air in the outlet channel 21 is measured. Depending on the measured temperature, the heating power of the heating cartridges 17, 18 is regulated and thus a constant hot air temperature corresponding to a preset value is achieved.

The amount of air can likewise be measured by a measuring apparatus and controlled via regulation.

The electrical and electronic components required for the sealing apparatus are advantageously located in a separate housing 24 which facilitates access and maintenance of the electrical components.

This pre-sealing process can, however, be carried out in particular as a preparatory step in order to seal the created pre-sealing seam 32 in a second sealing process, i.e., a final sealing process, in a manner impermeable to air to form a final sealing seam 54.

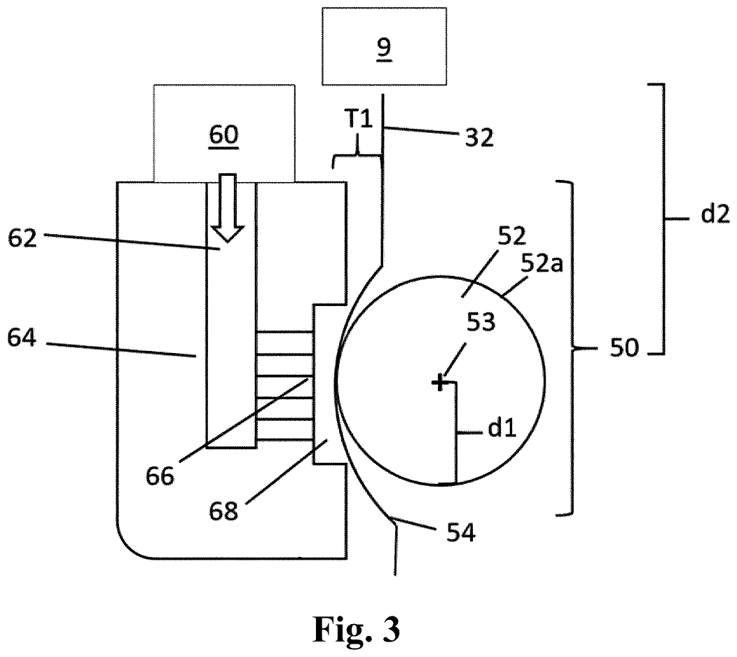

FIG. 3 illustrates a cross-section of a final sealing device 50.

The final sealing device 50 and, for example, the pressing device 52 in the form of a passive roller 52 mounted, in particular, on a ball bearing 53 or roller bearing 53, are described below, wherein the final sealing device 50 converts the pre-sealing seam 32 into an air-tight final sealing seam 54.

The roller 52 has an outer diameter d1 of 16 mm and is made of stainless steel at least on its smooth outer surface 52a. The stainless steel material has the properties that it is rustproof and heats up during the final sealing process, which leads to an advantageous result of the final sealing seam 54. Another possible material for the roller can be ceramic. The width of the roller 52, i.e., the contact surface on the film 1, should be at least as wide as the pre-sealing seam 32 so that pressure is exerted on each point of the pre-sealing seam 32 by the roller 52. The roller 52 can, for example, have a width of 5 mm. Tests must show whether an even narrower width would advantageously increase the pressure on the pre-sealing seam 32. The same applies to alternative diameters.

The roller 52 is a passively driven roller 52 that rotates on a ball bearing, thereby advantageously minimizing friction in the transport direction of the film 1. An actively driven roller, e.g., via an external motor, would theoretically be able to drive the rotational speed of the roller “even better” in synchronization with the transport speed of film 1, which in theory could reduce friction in the transport direction of film 1 even further. In practice, however, it has surprisingly been found that this theoretically better solution actually generates higher friction, in particular friction peaks, in the transport direction of the film 1, since the transport speed of the film varies to an extent that cannot be immediately compensated for in practice via a feedback loop, so that the roller 52 with the external drive would, for example, be operated at a “rigid” predetermined rotational speed different from the transport speed of the film 1, resulting in strong friction in the transport direction. The passive roller 52 surprisingly delivers better results in terms of protecting film 1. The variation in the transport speed of the film can in particular be caused by slippage in upstream or downstream processes.

The roller 52 is arranged so that it has an indentation depth T1 of 0.2-0.5 mm with respect to the plane of the film 1, in particular the local plane of the pre-sealing seam 32. This is to be understood geometrically as follows: the film 1, in particular the pre-sealing seam 32 and the final sealing seam 54 created by the roller 52, runs in a transport plane, wherein the roller 52 locally presses the pre-sealing seam 32 out of the plane with the indentation depth T1 and the film 1 can, for example, be guided back into the original transport plane as before the roller 52 after passing the roller 52. The roller 52 can press rigidly on the pre-sealing seam 32. The indentation depth T1 means that the pre-sealing seam 32 must travel a longer distance around the outer circumference of the roller 52, which generates the sealing pressure of the final sealing process. The greater the indentation depth T1, the greater the sealing pressure. Other parameters that influence the sealing pressure are, for example, the tension of film 1 and the transport speed. The higher the values of these parameters, the greater the sealing pressure.

A further aspect that can influence the indentation depth T1 is the distance of the roller 52 around the forming tube 4. The forming tube 4 has a decisive influence on where film 1, in particular the transport plane of film 1, runs. The distance between the roller and this forming tube 4 can fluctuate slightly due to various external influences so that the indentation depth T1 also changes. A sensor system can, for example, be provided that directly measures the distance between the roller 52 and the forming tube 4 and/or the indentation depth T1. If the indentation depth T1 deviates from a previously defined target value, a corresponding notification signal is generated by the sensor system so that the position of the roller 52 can be changed manually, for example, using adjusting screws, or automatically using an actuator so that the target value for the indentation depth T1 is set.

The fact that the film runs close to the forming tube 4 also has the following advantage: in particular in cheese production, but also for other warm foodstuffs, it may be intended that a heated cheese mass is introduced into the film tube 3 after the final sealing process. The heated cheese mass, for example, in a transport tube, can here be guided inside the forming tube 4 to a point after the final sealing process. This has the effect that the forming tube 4 is also heated by the heated cheese mass (up to a temperature of approximately 80° C.) which in turn results in heat transfer to the film 1 and has a beneficial effect on both the pre-sealing seam 32 and the final sealing seam 54.

To provide that the temperature of the pre-sealing seam 32 does not cool down too much after the pre-sealing apparatus 9, the final sealing device 50, i.e., in particular the roller 52, is, in terms of the process, arranged downstream of the pre-sealing apparatus 9 as far as possible., The distance d2 between the pre-sealing apparatus 9 and the final sealing device 50 is, for example, between 9-15 mm. It is thereby possible for the temperature of the pre-sealing seam 32 to be 100-150° C. when it is brought into contact with the roller 52.

It is particularly advantageous for the quality of the final sealing seam 54 if a counterpressure is generated on the opposite side of the passive roller 52. FIG. 3 shows a fluid pressure generating unit 60 which is designed to introduce a fluid under pressure into a fluid channel 62 along the direction of the arrow, wherein the fluid channel 62 is inserted into a fluid channel housing 64 and the fluid is guided in the direction of the passive roller 52 so that the fluid meets the pre-sealing seam 32 on the side opposite the passive roller 52. Here, in particular when the fluid emerges from the fluid channel housing 64, nozzles 66 are provided, which increase the pressure of the fluid as it emerges. In FIG. 3, normal air is used as the fluid. The fluid channel housing 64 can also have a pocket-like recess 68 so that the passive roller 52 can be brought as close as possible to the outlet openings of the nozzles 66.

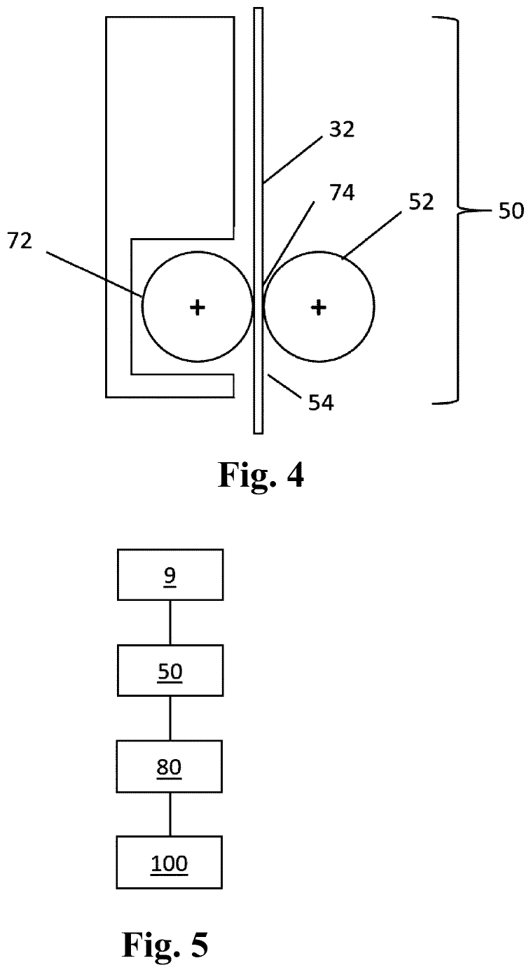

FIG. 4 illustrates a further exemplary embodiment of the final sealing device 50 in which the counterpressure is generated by a second roller 72, in particular a second passive roller 72, which is arranged opposite the first passive roller 52. The second passive roller 72 can in particular be identical in construction to the first roller 52. FIG. 4 shows that the film 1 with the pre-sealing seam 32 is fed through a gap 74 between the first roller 52 under the second roller 72. The gap 74 between the two rollers 52, 72 is narrower than the pre-sealing seam 32 so that pressure can be applied to the heated pre-sealing seam 32 to create the final sealing seam 54 which is impermeable to air. A variable sealing pressure can be set in a flexible manner by changing the dimensions of the gap 74. The exemplary embodiment with two rollers is particularly advantageous for thicker films for which higher friction is not critical and which in particular require higher pressure. It is possible to heat both rollers 52, 72 to improve the sealing result.

FIG. 5 schematically shows an overall process for producing a tight film packaging.

In a first step, the film 1 is supplied to the pre-sealing apparatus 9 as described above, as a result of which the pre-sealing seam 32 is formed. The film 1 with the pre-sealing seam 32 is then supplied to the final sealing device 50, wherein the air-tight final sealing seam 54 is created. Since film 1 is typically designed as a film tube 3 that is still open at the top and bottom in the transport direction 25, an insertion device 80 can be provided in a next step, which introduces a product, in particular a foodstuff such as cheese, into one of the open ends of the film tube 3.

In the next step, the film tube 3 must still be sealed in the transport direction 25 at the top and bottom transverse to the transport direction, in particular in an air-tight manner. This is carried out via a transverse sealing apparatus 100, which is described in detail below.

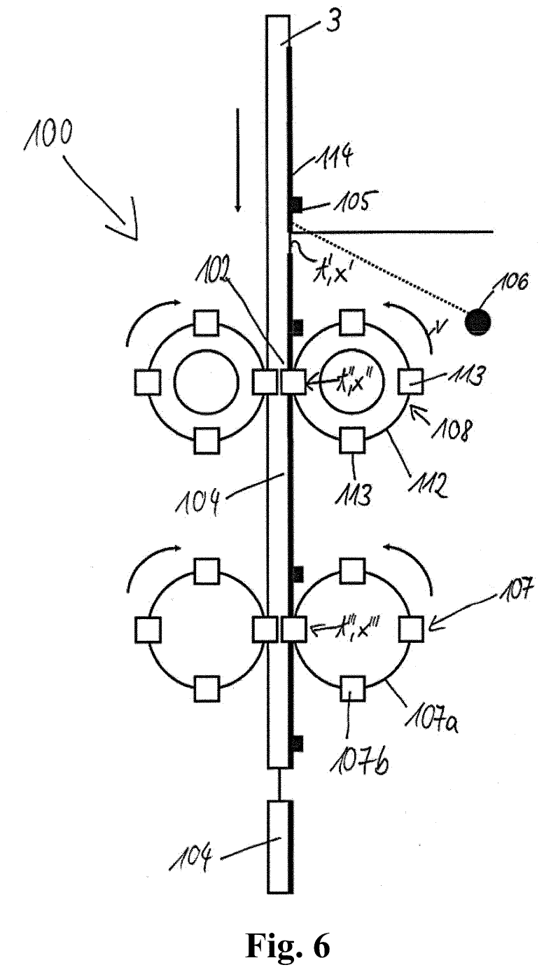

FIG. 6 shows in detail the transverse sealing apparatus 100 of the overall process according to FIG. 5.

The film tube 3 is guided along a tube conveying path by guide device (which is not shown). The film tube 3 can be filled with a product, in particular with a processed cheese mass, wherein the product packaged in the film tube 3 is separated into individually packaged slices. The method results in individually packaged products, in particular cheese slices of a certain size. In the present exemplary embodiment, each packaging can be provided with an image 114 that is precisely centered on the packaging and comprises product information in text form.

Each image 114 has a repeat mark 105 which is recognized by a sensor 106. A displacement area 102 is defined at a defined distance from the repeat mark 105, at which a displacement tool 108 is positioned in order to displace the product, in particular the processed cheese, from the displacement area 102. When the sensor 106 detects the repeat mark 105, the displacement area 102 is at a location x′ at the time t′ of detection. Based on the constant conveying speed v of the film tube 3, a displacement time t″ can then be calculated, at which the displacement area 102 is arranged at a location x″ along the conveying path, at which displacement then takes place by the displacement rollers 112 of a displacement tool 108. In the process, displacement surfaces 113 on the displacement rollers 112 are moved towards one another by rotation and there squeeze the film tube 3, as a result of which the product, in particular the processed cheese, is to be displaced out of the displacement area 102.

The film tube 3 is then sealed by a transverse sealing tool 107 with transverse sealing rollers 107a via transverse sealing surfaces 107b in the area of the displacement area 2. This creates the tight film packaging 104 for the product, in particular the cheese.

The sealed areas can then be cut through, for example, by a device as described in WO 2008/119633 A1, the disclosure of which is hereby explicitly incorporated by reference.

This ultimately results in the individual, air-tight, in particular inner, film packaging 104a.

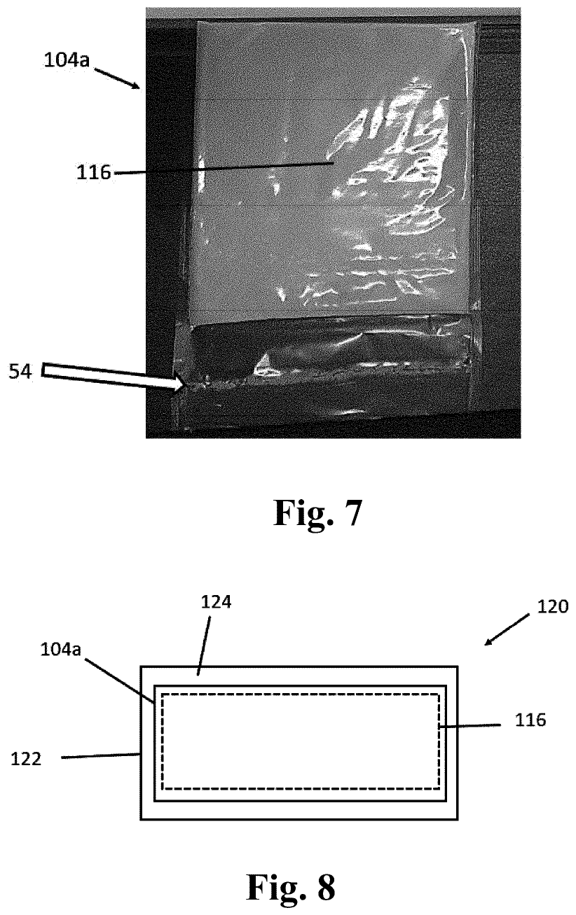

FIG. 7 shows an individual tight, in particular inner, film packaging 104a, which has at least one air-tight final sealing seam 54 as described above on one side of the individual tight film packaging 104a. The individual tight film packaging 104a is also air-tight along its other sides, so that a food product, such as a cheese product 116, may be contained in the individual film packaging 104a in an air-tight manner.

FIG. 8 shows a section through a combination packaging 120. The combination packaging 120 has an outer packaging 122 which encloses the individual tight film packaging 104a, wherein the cheese product 116 is in turn enclosed by the individual tight film packaging 104a. An intermediate space 124 is formed between the outer packaging 122 and the individual tight film packaging 104a which is unfumigated and therefore substantially only contains ambient air.

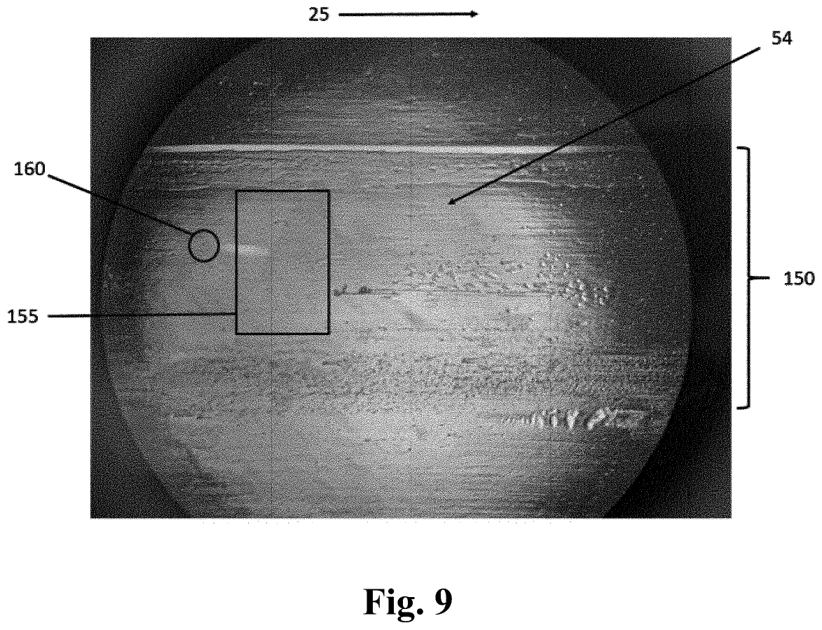

FIG. 9 shows a top view of a photograph of the air-tight final sealing seam 54 according to the present invention under a microscope, wherein the surface facing outward of the at least one film side can be seen. The final sealing seam 54 does not fill the entire area of the photograph, but in the vertical direction the central vertical area 150, which thus corresponds to the width of the final sealing seam 54, and in the horizontal direction up to the circular circumferential boundaries of the photograph. The final sealing seam 54 can have a width of 0.5 mm to 1.5 mm in the vertical direction. This width is thicker than with conventional sealing seams from the prior art, as the gentle and low-friction creation of the final sealing seam 54 means that a certain increased width is advantageous in order to provide air-tightness.

As described above, the entire sealing process of the air-tight final sealing seam 54 runs as smoothly and evenly as possible, which means that the fusion bond of the final sealing seam 54 between the two film sides is very homogeneous and the surfaces of the two film sides along the final sealing seam 54, in particular also the surface of the film side that is in contact with the roller 52, is very homogeneous and evenly smooth. The surface of the film sides is therefore substantially free of abrasion marks or traces of other mechanical stress. The sealing seam is thus evenly fused, more than 25%, for example, more than 50% of the area of the final sealing seam 54 is homogeneously 155 formed. Smaller inhomogeneities 160, in particular in the melt layer of the final sealing seam 54 between the two film sides, are in particular punctiform and have no preferred direction, in particular no tail in the transport direction 25. These small inhomogeneities can have a diameter of 1-5 μm.

As already described above, the surfaces are substantially smooth. Specifically, this can mean that the surfaces of the films have indentations along the final sealing seam 54 which correspond to at most 25%, for example, at most 10%, for example, at most 5% of the thickness of the film thickness. If the film has a thickness of 20 μm, then mechanical stresses, for example, from the roller 52, therefore have at most resulted in indentations with a depth of at most 10 μm, at most 5 μm or at most 2 μm. The film is therefore virtually undamaged and it is even possible to use even thinner films. A structure of the final sealing seam 54 according to the present invention could be described in this way.

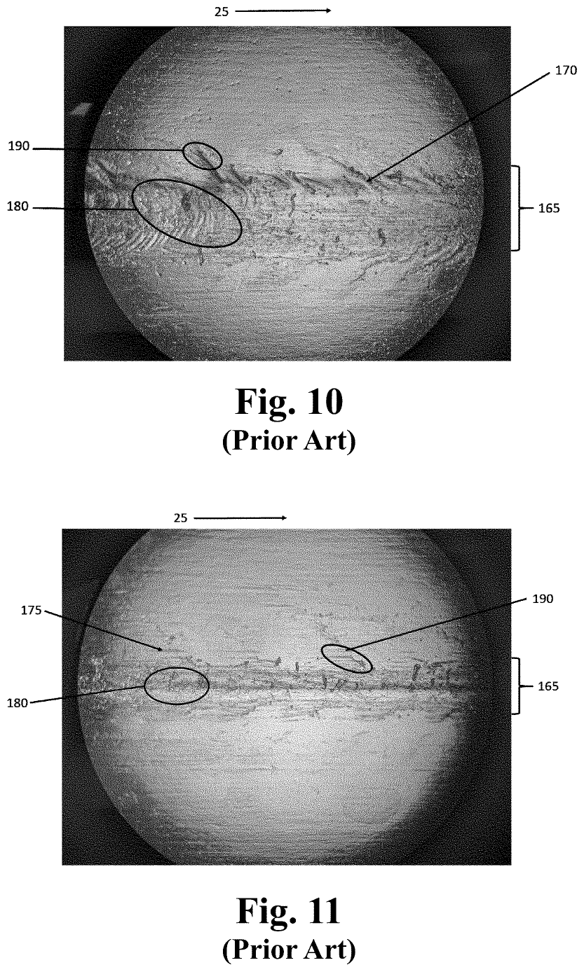

FIG. 10 shows a top view of another sealing seam produced according to another method from the prior art, and FIG. 11 shows a top view of a further sealing seam produced according to a further method from the prior art. Since the two films according to FIGS. 10 and 11 differ from the final sealing seam 54 according to the present invention in many structural features in a similar manner, FIGS. 10 and 11 are described together.

The differences to the photograph in FIG. 9, i.e., the final sealing seam 54 according to the present invention, are immediately apparent. The width 165 of the sealing seam 170 of the other method and the width 165 of the sealing seam 175 of the further method are each less than 0.5 mm. A strong mechanical pressure is exerted on the at least one surface of the film when the sealing seams 170, 175 are created, resulting in severe surface damage 180 so that the film has indentations along the sealing seam that may correspond to the thickness of the film. These sealing seams 170, 175 do not have homogeneous areas. In addition, many damages have a tail 190 in the transport direction 25 which is caused by mechanical force being applied to the film in transport direction 25 at transport speed.

The present invention is not limited to embodiments described herein; reference should be had to the appended claims.

### LIST OF REFERENCE SIGNS

1 film/flat film web
2 forming shoulder
3 film tube (open)
4 forming tube
5 holder (for forming shoulder 2 and forming tube 4)
6 suspension (for pre-sealing apparatus 9)
7 pivot bearing
8 fastening arm
9 pre-sealing apparatus
10 pivot arm (on holder 5)
11 fastening screw
12 stop adjustment
13 inclination adjustment
14 housing (of the pre-sealing apparatus 9)
15 air inlet
16 distribution channel
17 first heating cartridge
18 second heating cartridge
19 overflow channels
20 overflow channels
21 outlet channel
22 outlet nozzles
23 temperature sensor
24 separate housing (for electrical components)
25 transport direction
32 pre-sealing seam
50 final sealing device
52 pressing device/roller/passive roller/first passive roller
52a outer surface
53 ball bearing/roller bearing
54 final sealing seam
60 fluid pressure generation unit
62 fluid channel
64 fluid channel housing
66 nozzles
68 pocket-like recess (of the fluid channel housing 64)
72 second roller/second passive roller
74 gap
80 insertion device
100 transverse sealing apparatus
102 displacement area
104 tight film packaging
104a individual tight film packaging (IWS)
105 repeat mark
106 sensor
107 transverse sealing tool
107a transverse sealing roller
107b transverse sealing surface
108 displacement tool
112 displacement roller
113 displacement surface
114 image
116 cheese product
120 combination packaging
122 outer packaging
124 intermediate space
150 central vertical area
155 homogeneously formed final sealing seam 54
160 smaller inhomogeneities
165 width of sealing seam
170 sealing seam of the prior art
175 sealing seam of the prior art
180 surface damage
190 tail
T1 indentation depth
d1 outer diameter (of roller 52)
d2 distance (between the pre-sealing apparatus 9 and the final sealing device 50)

What is claimed is:

1-15. (canceled)

16.: A method for producing a sealing seam which joins two film sides, the method comprising:
performing a pre-sealing process comprising:
heating at least one film side of the two film sides, and
in a heated state of the at least one film side, bringing both of the two film sides into contact with one another so as to form a pre-sealing seam which joins the two film sides together as a film; and
performing a final sealing process comprising:
supplying the pre-sealing seam at a transport speed to a pressing device which is arranged downstream of the pre-sealing process, and
applying a force via the pressing device to at least one film side of the two film sides along the pre-sealing seam substantially perpendicular to the transport direction so as to transform the pre-sealing seam into a final sealing seam which is substantially impermeable to air.

17.: The method as recited in claim 16, wherein,
the two film sides are two film sides of the film in the formation of a film tube, and
the pressing device is arranged as close as is structurally possible downstream of the pre-sealing process.

18.: The method as recited in claim 16, wherein the pressing device is arranged to project into a transport plane of the transport direction of the pre-sealing seam so that the pre-sealing seam runs around the pressing device and the force is applied to the one film side of the pre-sealing seam.

19.: The method as recited in claim 16, wherein the pressing device is designed as a roller.

20.: The method as recited in claim 19, wherein the roller is designed as a passive roller which is configured to be driven by a friction with the film.

21.: The method as recited in claim 20, wherein the passive roller is configured to be driven by a friction with the pre-sealing seam of the film.

22.: The method as recited in claim 19, wherein the roller comprises at least one of,
an outer surface which is smooth, and
a material with a high heat storage capacity at least on the outer surface.

23.: The method as recited in claim 22, wherein the material with the high heat storage capacity is stainless steel.

24.: The method as recited in claim 19, further comprising:
providing a counterpressure on an opposite side of the pressing device via a further roller.

25.: The method as recited in claim 16, further comprising:
providing a counterpressure on an opposite side of the pressing device by applying a force to a fluid.

26.: The method as recited in claim 16, wherein the pre-sealing seam of the pre-sealing process is formed by blowing hot air onto the film.

27.: The method as recited in claim 16, wherein the two film sides form an O-film tube as the film, wherein one side of the O-film tube rests on the other side of the O-film tube.

28.: The method as recited in claim 16, wherein the film has a thickness of less than 30 μm.

29.: A device for producing a sealing seam which air-tightly joins two film sides, the device comprising:
a pre-sealing apparatus which comprises a heating device; and
a final sealing device which is arranged downstream of the pre-sealing apparatus in a transport direction of the two film sides, the final sealing device comprising a pressing device which is configured to provide a force,
wherein,
the pre sealing apparatus is configured to perform a pre-sealing process comprising:
heating at least one film side of the two film sides in a pre-sealing process via the heating device of the pre-sealing apparatus, and
in a heated state of the at least one film side, bringing both of the two film sides into contact with one another so as to form a pre-sealing seam which joins the two film sides together as a film, and the final sealing device is configured to perform a final sealing process comprising:
supplying the pre-sealing seam at the transport speed to the pressing device which is arranged downstream of the pre-sealing process, and
applying the force via the pressing device to at least one film side of the two film sides along the pre-sealing seam substantially perpendicular to the transport direction so as to transform the pre-sealing seam into a final sealing seam which is air-tight.

30.: The device as recited in claim 29, wherein the two film sides are two film sides of a film in the formation of a film tube.

31.: An air-tight sealing seam which is obtained via the method as recited in claim 16.

32.: An air-tight film packaging comprising:
at least the air-tight sealing seam as recited in claim 31 which is configured to seal a film tube along one side; and
two air-tight transverse seals.

33.: The air-tight film packaging as recited in claim 32, wherein the air-tight film packaging is for a foodstuff.

34.: A combination packaging comprising:
the inner air-tight film packaging as recited in claim 32; and
an outer packaging which surrounds the inner air-tight film packaging,
wherein,
an intermediate space between the outer packaging and the inner air-tight film packaging is unfumigated.

35.: A combination packaging for a foodstuff, the combination packaging comprising:
an inner air-tight film packaging; and
an outer packaging which surrounds the inner air-tight film packaging,
wherein,
an intermediate space between the outer packaging and the inner air-tight film packaging is unfumigated, and
the inner air-tight film packaging comprises a smooth, homogeneous longitudinal sealing seam.
